(19) United States
(12) Patent Application Publication
(10) Pub. No.: US 2021/0197602 A1
(43) Pub. Date: Jul. 1, 2021

(54) Method for Transposing Multi-Event Sports Meet Information on Skin with a Rotating Type Stamp

(71) Applicant: Matthew Joseph Schomaker, Gibsonia, PA (US)

(72) Inventor: Matthew Joseph Schomaker, Gibsonia, PA (US)

(21) Appl. No.: 16/729,331

(22) Filed: Dec. 28, 2019

(51) Int. Cl. B41K 1/12; B41K 1/50; B41K 1/52; B41K 1/54

(52) U.S. Cl. CPC B41K 1/12; B41K 1/54; B41K 1/52; B41K 1/50

(57) ABSTRACT

A method for transposing multi-event sports meet information on skin comprises the steps of using a rotating type stamping device mechanism where multiple selections can be made to refine event specifics. These specifics which may include event number, heat number, lane number, stroke, and distance information are then stamped onto an athlete's skin with the device. Multiple lines can be stamped covering an array of events. Stamping creates a clear image and requires no writing by hand on the skin to populate the event information.

### REFERENCES CITED

### US Patent Documents

| | | |
|---|---|---|
| 692,245 | February 1902 | Cressler |
| 1,134,950 | June 1915 | Folger and Redfield |
| 1,353,994 | September 1920 | Folger and Ross |
| 2,088,009 | July 1937 | Melind |
| 2,089,549 | August 1937 | Grant |
| 2,193,564 | March 1940 | Melind |
| 4,176,600 | December 1979 | Sato |
| 4,321,868 | March 1982 | Kikuchi |
| 4,858,526 | August 1989 | Bengtsson |
| 5,517,916 | May 1996 | Dour et al. |
| 5,649,485 | July 1997 | Dour et al. |
| 5,743,889 | April 1998 | Uzi |
| 6,286,682 | September 2001 | d'Arbelles |
| 6,360,658 | March 2002 | Benson |
| 6,679,168 | November 2005 | Shih |
| 6,964,229 B1 | November 2005 | Zimmerman |

### BACKGROUND

There is a variety of multi-event sports meets where athletes of all ages compete in multiple events throughout the meet. Athletes often require quick reference while moving closer to the event time on which event number they are scheduled to compete along with information such as heat and lane numbers. The distance and stroke for instance in swimming is also something that varies from event to event.

The information is provided to the athletes and the younger athletes' parents in most instances in the form of booklet or multiple page heat sheet that is stapled together. At times younger children 5-12 years old cannot follow the heat sheet booklet and require their parent or guardians help. Athletes need this information to be readily available to make sure events are not missed and when they line up behind the starting point they are in the right position. Having the distance and stroke written is a reminder for the younger swimmers so they can be reassured and confident when they are lined up behind the starting point. Meets and sports where this information is required include swimming, gymnastics, and track and field.

Practice of writing heat, lane, and stroke information on an athlete's hand or body has been used for decades with ink pens and markers. Recently there have been grid systems developed where a stamped grid is used and the information is hand written within the grid. Sloppiness of hand writing on skin with markers or ink pens causes problems with clarity of the information written on the skin. Often times the child's hands are small and permanent markers can require larger letters to be legible. A development is needed where clear information can be stamped on the athlete without the need to hand write with pens or markers. A stamp with all the pertinent information will provide a clear legible means to transpose this information neatly without handwriting.

### SUMMARY

The present disclosure is directed to a method that satisfies this need.

For purposes of describing the invention, certain aspects and features of the invention have been described herein. It is to be understood that not necessarily all such advantages may be achieved with any one particular embodiment of the invention. Therefore, the invention may be embodied or carried out in a manner that achieves one advantage as taught herein without necessarily achieving other advantages as may be taught or suggested herein.

The method comprises the steps of using a rotating type stamping device mechanism where multiple selections can be made to refine event specifics. These specifics which may include event number, heat number, lane number, stroke, and distance information are them stamped onto an athlete's skin with the device. Multiple lines can be stamped covering an array of events. Stamping creates a clear image and requires no writing by hand on the skin to populate the event information. This ink used either within the stamping device or the ink pad used may be resistant to erasure from exposure to liquid, including water or perspiration.

A header with a description can also be transposed from the rotating stamping device. The description header could contain abbreviations for the heat (H), stroke (STR) Lane (L) and Event number that can help guide the athlete when reviewing the other pertinent stamped information.

### BRIEF DESCRIPTION OF THE DRAWINGS

The accompanying drawings show one preferred embodiment of the Multi-Event Stamp rotary stamping device according to this invention, wherein:

FIG. 1 depicts a rotating type stamping device for use in the present inventive method.

FIG. 2 depicts one form of associated column information that could be populated within the stamping device.

FIG. 3 depicts the display rendered by the stamping device in ink when multiple stamp rows are impressed upon a surface.

### DETAILED DESCRIPTION

For purposes of the description hereinafter, character references and special orientation, if used shall relate the referenced embodiment as it is oriented in the drawings or otherwise described in the following detailed description. However, it is to be understood that the embodiments described hereinafter may assume many alternative variations and embodiments. It is also to be understood that the specific embodiments illustrated in the accompanying drawings described herein are simply exemplary and should not be considered as limiting.

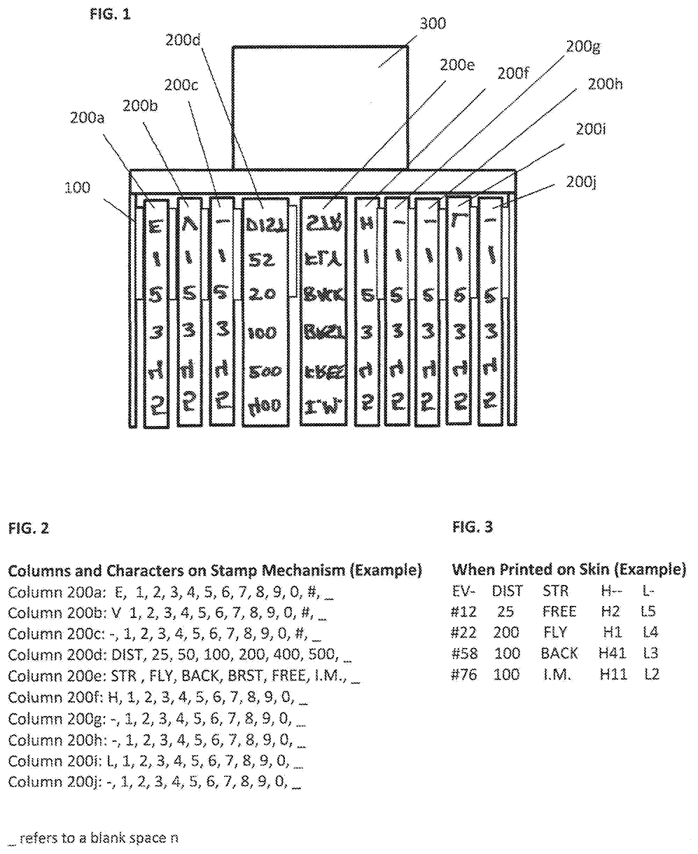

A hand stamp or rotating ink stamp device FIG. 1 having rotating characters with populated event information that can be selected and imprinted on the skin or other surface. FIG. 1 shows an example of a rotating hand stamp that would be used with an external ink pad. A a self-inking rotary type stamp device could also be used. Associated characters within the stamp consist of a general description of the events 200a-j that can be stamped to provide a heading or title information for specific event information to be populated above or below. The categories located within 200a-j may appear in any order in the array. Meet information categories shown in 200a-j do not need to be represented by the full word and can be abbreviations as shown in FIG. 1-3. Abbreviations can include EV for Event, STR for Stroke, FREE for Freestyle and so forth.

Information used to populate specific event information is also located within the rotational selections of the stamp. An example of the character population for the given columns of the stamp are shown in FIG. 3. Multiple lines can be stamped covering an array of events. Stamping creates a clear image and requires no writing by hand on the skin to populate the event information. The characters in the stamp are rotated using a dial as shown in 100 or other rotating mechanism. FIG. 3 shows an example of a finalized stamp impression made for a meet where the athlete would be in 4 events. The description of the specific events are imprinted in 4 separate horizontal stamp rows. The rotational aspect of the stamp allows for customized selections for event number, distance, stroke, heat, and lane as shown in FIG. 1-3.

While larger or smaller stamps can be used, the width of the array as shown in the FIG. 1 is 2.5 inches wide. The size of the rotational character size can also vary but as depicted the characters as shown as approximately 0.25 inches tall by 0.25 inches wide.

The Stamp can be made of any material suitable for supporting die including rubber, wood, plastic, or metal. Various colors and types of ink could be used with this device.

1. A method for transposing multi-event athletic competition information on an athlete's skin without the need for handwritten population. This method comprised of the steps: Stamping or printing rows of information using a rotating adjustable ink stamp mechanism or similar device on an athlete's skin. Adjusting the stamp to reflect the specific information for each event and stamping multiple rows to cover multiple events.

2. The method of claim 1 where said ink is resistant to erasure from water or perspiration.

3. The method of claim 1 where an abbreviated description row could also be inked in the athlete's hand or other body part using the rotating adjustable stamp mechanism or similar device.

4. The method of claim 1 where the stamp could be a self-inking, pre inking or other stamp utilizing an internal ink.

5. The method of claim 1 where the ink is located outside the stamping device on an ink pad for example.
